(19) United States
(12) Patent Application Publication
(10) Pub. No.: US 2002/0180201 A1
(43) Pub. Date: Dec. 5, 2002

(54) Vehicle occupant safety system with an electric motor driven pretensioner

(76) Inventors: Theodore W. Nye, Palos Verdes Estates, CA (US); Laird A. Fosse, Hermosa Beach, CA (US)

Correspondence Address: TAROLLI, SUNDHEIM, COVELL,, TUMMINO & SZABO L.L.P., 1111 LEADER BLDG., 526 SUPERIOR AVENUE, CLEVELAND, OH, 44114-1400, US

(21) Appl. No.: 09/873,014

(22) Filed: Jun. 1, 2001

(51) Int. Cl. B60R 22/36

(52) U.S. Cl. 280/806; 180/274

(57) ABSTRACT

A vehicle occupant safety system (10) for helping to protect an occupant (12) of a vehicle seat (14) during a crash condition comprises at least one sensor (174) for sensing a vehicle crash condition and generating a signal indicative of the crash condition. The vehicle occupant safety system (10) also includes seat belt webbing (20) for extending around the vehicle occupant (12) and a pretensioner (24). The pretensioner (24) is responsive to the signal generated by the sensor (174) for acting on the seat belt webbing (20) to pull an occupant (12) of the vehicle seat (14) who is forward in the seat (14) backward toward a back portion (18) of the seat (14). The pretensioner (24) comprises a seat belt retractor (26) that includes a spool (34) on which the seat belt webbing (20) is wound and an electric motor (108) for rotating the spool (34) in a belt retraction direction (172).

### TECHNICAL FIELD

The present invention relates to a vehicle occupant safety system. In particular, the present invention relates to a vehicle occupant safety system having an electric motor driven retractor.

### BACKGROUND OF THE INVENTION

A typical vehicle seat belt system includes a length of seat belt webbing wound on a spool of a seat belt webbing retractor. The seat belt webbing is extensible about a vehicle occupant for helping to restrain the occupant in the event of a vehicle crash condition. The spool rotates in a belt withdrawal direction as the occupant withdraws seat belt webbing from the retractor. A rewind spring is connected with the spool and biases the spool for rotation in an opposite belt retraction direction.

While seated in a vehicle seat, an occupant may lean forward in the seat. It is known to use a pretensioner to apply a force to the seat belt webbing to pull a forward leaning occupant back against a back portion of the seat in the event of a vehicle crash condition. Typically, a pretensioner includes a pyrotechnic device that is actuated when a crash condition is sensed. After actuation of the pyrotechnic device, the pretensioner must be replaced.

It is desirable to provide a vehicle with an electric motor driven pretensioner that does not require replacement after a single use.

### SUMMARY OF THE INVENTION

The present invention is a vehicle occupant safety system for helping to protect an occupant of a vehicle seat during a crash condition. The vehicle occupant safety system comprises at least one sensor for sensing a vehicle crash condition and generating a signal indicative of the crash condition. The vehicle occupant safety system also includes seat belt webbing for extending around the vehicle occupant and a pretensioner. The pretensioner is responsive to the signal generated by the sensor for acting on the seat belt webbing to pull an occupant of the vehicle seat who is forward in the seat backward toward a back portion of the seat. The pretensioner comprises a seat belt retractor. The seat belt retractor includes a spool on which the seat belt webbing is wound and an electric motor for rotating the spool in a belt retraction direction to pull the occupant backward toward the back portion of the vehicle seat.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a schematic illustration of a vehicle occupant safety system constructed in accordance with the present invention;

FIG. 2 is a cross-sectional view of a retractor of the vehicle occupant safety system of FIG. 1;

FIG. 3 is an exploded view of the retractor of FIG. 2;

FIGS. 4A and 4B illustrate schematically the engagement of portions of the gear assembly of the retractor of FIG. 2;

FIG. 5 illustrates an occupant of a vehicle in a forward position in the vehicle seat and being restrained by the vehicle occupant safety system of FIG. 1; and

FIG. 6 illustrates an occupant of a vehicle in a position against the seat back of the vehicle seat and being restrained by the vehicle occupant safety system of FIG. 1.

### DETAILED DESCRIPTION OF THE INVENTION

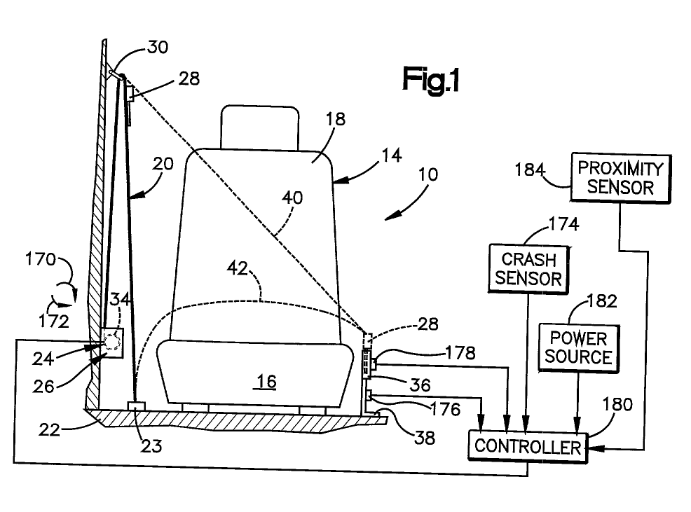

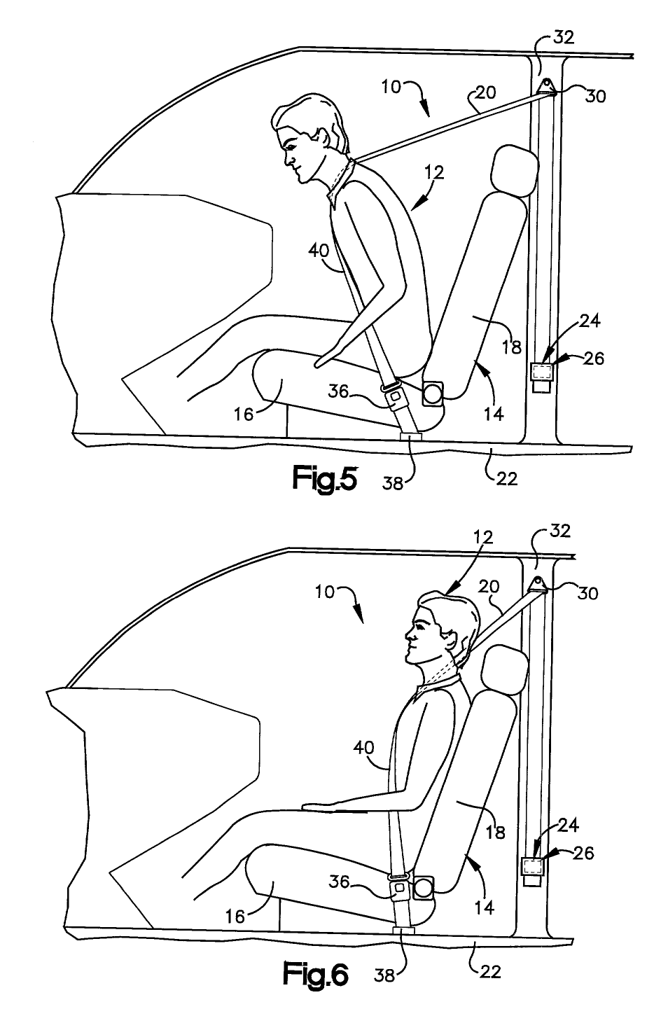

The present invention relates to a vehicle occupant safety system 10 for helping to protect an occupant 12 (FIGS. 5 and 6) of a vehicle seat 14 during a vehicle crash condition. FIG. 1 illustrates a vehicle occupant safety system 10 constructed in accordance with the present invention. The vehicle occupant safety system 10 illustrated in FIG. 1 is a three-point continuous loop seat belt system for use in helping to restrain an occupant 12 of a vehicle in the vehicle seat 14. Those skilled in the art will recognize that the vehicle occupant safety system 10 may be a system other than a three-point continuous loop seat belt system.

In FIG. 1, the vehicle seat 14 is illustrated as a front passenger seat. The vehicle seat 14 includes a bottom portion 16 and a back portion 18. Ideally, when seated on the vehicle seat 14, an occupant 12 of the vehicle will be seated on the bottom portion 16 of the seat 14 with the occupant's back against the back portion 18 of the seat 14, as illustrated in FIG. 6.

The vehicle occupant safety system 10 includes a length of seat belt webbing 20 that is extensible about the seated occupant 12. As shown in FIG. 1, one end of the length of seat belt webbing 20 is anchored to the vehicle body 22 at an anchor point 23 located on one side of the seat 14. The opposite end of the seat belt webbing 20 is attached to a pretensioner 24. The pretensioner 24 comprises a retractor 26, which includes an electric motor 108 as discussed in detail below. The pretensioner 24, including the retractor 26, is secured to the vehicle body 22 on the same side of the seat 14 as anchor point 23. A tongue assembly 28 is attached to the seat belt webbing 20 intermediate the ends of the seat belt webbing 20. The position of the tongue assembly 28 relative to the ends of the seat belt webbing 20 is adjustable.

A D-ring 30 is mounted to the vehicle body 22, illustrated as a B-pillar 32 in FIGS. 5 and 6, in a position above the pretensioner 24, including the retractor 26, and anchor point 23. The seat belt webbing 20 extends from anchor point 23 and through the D-ring 30 before entering the retractor 26.

When the seat belt system is not in use, the seat belt webbing 20 is wound on a spool 34 of the retractor 26 and is oriented generally vertically on the one side of the seat 14, as shown in solid lines in FIG. 1. To engage the seat belt system, the tongue assembly 28 is manually grasped and is pulled across the lap and torso of the occupant 12 seated in the seat 14. As the tongue assembly 28 is pulled, the electric motor 108 is energized to unwind a portion of the seat belt webbing 20 from the spool 34 of the retractor 26. The manner in which the electric motor 108 unwinds a portion of the seat belt webbing 20 is described in detail below. The tongue assembly 28 is latched in a buckle 36, as shown in dashed lines in FIG. 1. A buckle anchor 38 attaches the buckle 36 to the vehicle body 22 on a side of the seat 14 opposite anchor point 23.

When the seat belt system is latched or buckled, the length of seat belt webbing 20 between anchor point 23 and the D-ring 30 is divided into a torso portion 40 and a lap portion 42. The torso portion 40 extends from the D-ring 30 to the tongue assembly 28 and extends across the torso of the occupant 12. The lap portion 42 extends from the tongue assembly 28 to anchor point 23 and extends across the lap of the occupant 12. The remainder of the seat belt webbing 20, not forming the torso portion 40 or the lap portion 42, extends from the D-ring 30 into the retractor 26 and is wound around the spool 34 of the retractor 26.

During movement of the tongue assembly 28 toward the buckle 36, the tongue assembly 28 moves along the seat belt webbing 20. The movement of the tongue assembly 28 assures that the lap portion 42 of the seat belt webbing 20 fits snugly across the lap of the occupant 12. The retractor 26 controls the snugness of the torso portion 40 of the seat belt webbing 20 in a manner that will be discussed in detail below.

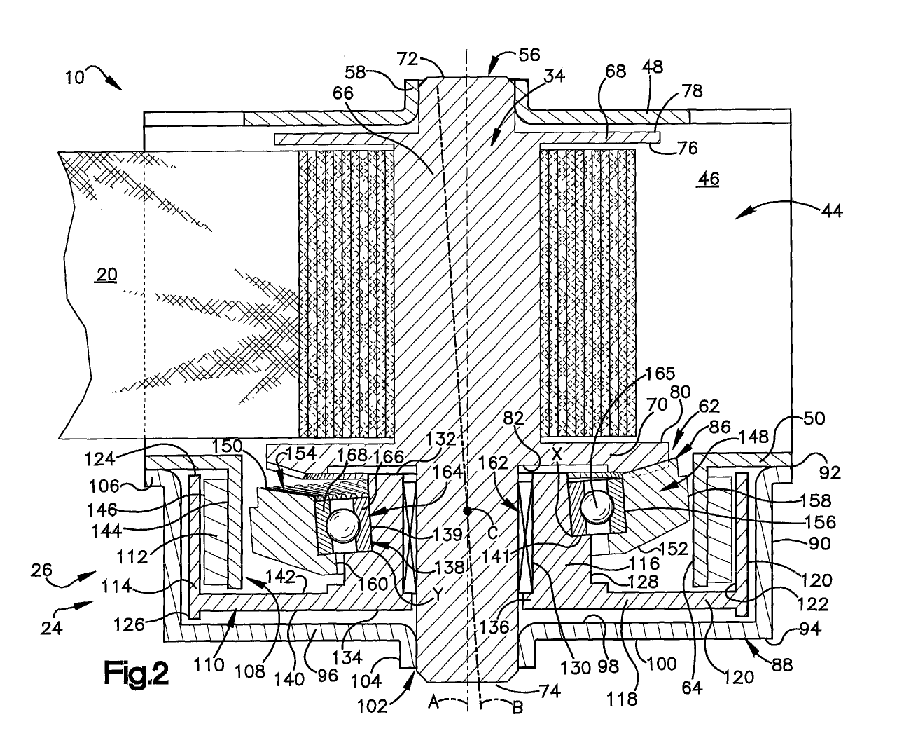

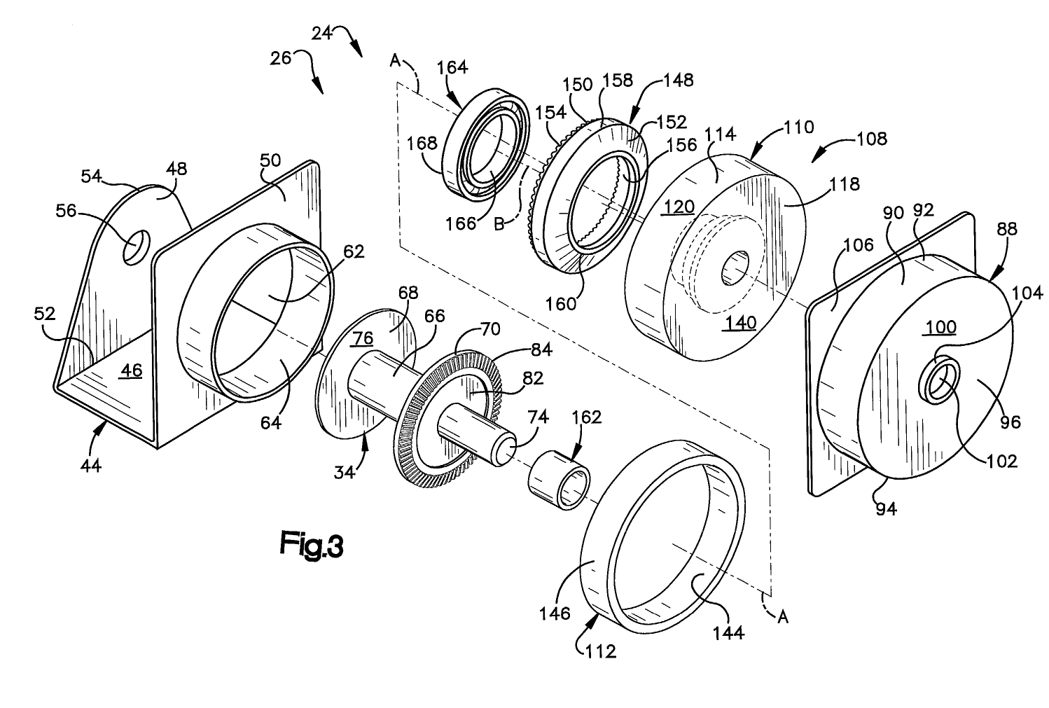

FIGS. 2 and 3 illustrate the retractor 26 of the vehicle occupant safety system 10 of FIG. 1. FIG. 2 is a cross-sectional view of an assembled retractor 26. FIG. 3 is an exploded view of the retractor 26 of FIG. 2.

The retractor 26 includes a frame 44. The frame 44 of the retractor 26 is fixed to the vehicle body 22 in a known manner. As best shown in FIG. 3, the frame 44 is a single piece of sheet metal that is stamped and formed into a U-shaped configuration. The frame 44 includes a back wall 46, a first side wall 48, and a second side wall 50. The back wall 46 forms the closed portion of the U-shaped configuration. The first and second side walls 48 and 50 form the legs of the U-shaped configuration.

The back wall 46 of the frame is rectangular. The back wall 46 has a width that is defined as the distance between the first side wall 48 and the second side wall 50. The back wall 46 has a length that extends in a direction perpendicular to the width. The length of the back wall 46 is approximately twice as long as the width of the back wall 46.

The first side wall 48 of the frame 44 has a base 52 (FIG. 3) with a length equal to the length of the back wall 46 of the frame 44. The first side wall 48 narrows as it extends away from the back wall 46 and terminates in a curved upper portion 54. A hole 56 extends through the first side wall 48. An outwardly bent surface 58 (FIG. 2) defines the hole 56. The hole 56 is centrally located along the length of the base 52 of the first side wall 48 and is located approximately three-quarters of the height of the first side wall 48 away from the base 52.

The second side wall 50 of the frame is generally square in shape and has two upper corners 60 that are chamfered. The second side wall 50 has a length and a height that are approximately equal to the length of the back wall 46 of the frame 44. A centrally located hole 62 in the second side wall 50 is coaxial with the hole 56 in the first side wall 48. The hole 62 in the second side wall 50 has a diameter that is approximately four and a half times the diameter of the hole 56 in the first side wall 48. A cylindrical extension 64 extends axially outwardly from the second side wall 50 to define the hole 62. Those skilled in the art will recognize that a separate cylindrical extension 64 may be attached to the second side wall 50 in a known manner to form the cylindrical extension 64 defining the hole 62.

The retractor 26 further includes a spool 34. The spool 34 has a cylindrical axle 66, a first support wall 68, and a second support wall 70. The first and second support walls 68 and 70 help to maintain seat belt webbing 20 on the spool 34 in an orderly manner.

The axle 66 of the spool 34 is centered on axis A and includes a first terminal end 72 (FIG. 2) and a second terminal end 74. The axle 66 has a length that is approximately 50% greater than the width of the back wall 46 of the frame 44. The length of the axle 66 is defined as the distance between the first and second terminal ends 72 and 74.

The first support wall 68 is disk shaped and is fixed to the axle 66 near the first terminal end 72 of the axle 66. The first support wall 68 has an inner surface 76 and an outer surface 78 (FIG. 2). A short portion of the axle 66, including the first terminal end 72, extends outwardly along axis A beyond the outer surface 78 of the first support wall 68.

The second support wall 70 is located between the first support wall 68 and the second terminal end 74 of the axle 66. The distance between the first support wall 68 and the second support wall 70 is slightly less than the width of the back wall 46 of the frame 44, but slightly greater than a width of the seat belt webbing 20. The second support wall 70 is also disk shaped and has a radius that is slightly greater than the radius of the first support wall 68. The second support wall 70 has an inner surface 80 and an outer surface 82. The outer surface 82 of the second support wall 70 includes a plurality of teeth 84 (FIG. 3) that extend in a circular array around the periphery of the second support wall 70. The second support wall 70 forms a part of a gear assembly 86 (FIG. 2) as will be described in detail below. A portion of the axle 66, constituting approximately one-third of the axial length of the axle 66 and including the second terminal end 74, extends outwardly along axis A beyond the outer surface 82 of the second support wall 70.

As shown in FIG. 3, the retractor 26 also includes a motor cover 88. The motor cover 88 includes a cylindrical main body portion 90. The main body portion 90 extends axially between a first axial end 92 and a second axial end 94. An end wall 96 closes the second axial end 94 of the main body portion 90. The end wall 96 has an inner surface 98 (FIG. 2) and an outer surface 100. A centrally located hole 102 extends through the end wall 96. A short cylindrical extension 104 extends axially away from the cylindrical main body portion 90 of the motor cover 88 to define the hole 102. A flange 106 extends radially outwardly from the first axial end 92 of the cylindrical main body portion 90 of the motor cover 88. The flange 106 has a generally square configuration and has outer dimensions equal to those of the second side wall 50 of the frame 44.

The retractor 26 further includes an electric motor 108 (FIG. 2). Preferably, the electric motor 108 is a low inertia, permanent magnet, DC motor. The electric motor 108 includes a rotor 110 and a stator 112. The stator 112 is rotationally fixed and the rotor 110 rotates relative to the stator 112 in a known manner. The electric motor 108 has a mathematical thermal time constant, as in known in the art, that can be used to calculate the time required to damage the motor by overloading or overheating. As will be discussed below, the thermal time constant can also be used to indicate the amount of time it takes for an electric motor 108 temperature to reach a certain value.

As shown in FIG. 2, the rotor 110 of the electric motor 108 is generally cup-shaped and includes an outer cylindrical wall 114, an inner cylindrical wall 116, and an end wall 118 that connects the outer cylindrical wall 114 to the inner cylindrical wall 116. The outer cylindrical wall 114 has an outer surface 120 and an inner surface 122 (FIG. 2). The outer cylindrical wall 114 extends axially from a first axial end 124 to a second axial end 126. An axial length of the outer cylindrical wall 114 is slightly less than the axial length of the main body portion 90 of the motor cover 88. The inner surface 122 of the outer cylindrical wall 114 includes a plurality of permanent magnets (not shown) that are spaced in a circular array around the outer cylindrical wall 114. The permanent magnets form rotor poles.

The inner cylindrical wall 116 of the rotor 110 has an outer surface 128 and an inner surface 130. The outer surface 128 of the inner cylindrical wall 116 is nearest the inner surface 122 of the outer cylindrical wall 114. The inner cylindrical wall 116 extends axially from a first axial end 132 to a second axial end 134. The axial length of the inner cylindrical wall 116 is slightly less than the axial length of the outer cylindrical wall 114. The thickness of the inner cylindrical wall 116, defined as the distance between the inner surface 130 and the outer surface 128, is approximately five times the thickness of the outer cylindrical wall 114. The inner surface 130 of the inner cylindrical wall 116 includes an annular rib 136 (FIG. 2) that extends radially inwardly from the inner surface 130. The rib 136 is located adjacent the second axial end 134 of the inner cylindrical wall 116.

The outer surface 128 of the inner cylindrical wall 116 includes a groove 138 that extends around the circumference of the inner cylindrical wall 116. The groove 138 is defined by two surfaces. An inner surface 139 of the groove 138 is cylindrical and extends from first axial end 132 of the inner cylindrical wall 116 of the rotor 110 toward the second axial end 134 of the rotor 110. The inner surface 139 is centered on an axis B that is angled or tilted from axis A, as shown in FIG. 2. An end surface 141 of the groove 138 extends into the outer surface 128 of the inner cylindrical wall 116 in a direction perpendicular to axis B and connects to the inner surface 139 of the groove 138. Thus, the end wall 141 of the groove 138 is tilted relative to a perpendicular of axis A as the groove 138 extends annularly around the outer surface 128 of the inner cylindrical wall 116 of the rotor 110. Specifically, a portion, indicated as X in FIG. 2, of the groove 138 is nearer the first axial end 132 of the inner cylindrical wall 116 of the rotor 110 and a portion, indicated as Y in FIG. 2, of the groove 138 opposite portion X is nearer the second axial end 134 of the inner cylindrical wall 116 of the rotor 110 so that end wall 141 is perpendicular relative to axis B.

The end wall 118 of the rotor 110 has an outer surface 140 and an inner surface 142. The end wall 118 connects the second axial end 126 of the outer cylindrical wall 114 to the second axial end 134 of the inner cylindrical wall 116.

As shown in FIG. 3, the stator 112 of the electric motor 108 is tubular. The stator 112 has an inner surface 144 and an outer surface 146. The stator 112 has an axial length that is less than the axial length of the outer cylindrical wall 114 of the rotor 110. The stator 112 includes a plurality of stator poles (not shown). Each stator pole includes field windings (not shown) that receive electric energy through leads (not shown).

Assembly of the electric motor 108 will be discussed below with reference to the assembly of the retractor 26. The electric motor 108 described is for illustration purposes only and that other electric motor designs may be used.

The retractor 26 further includes a gear assembly 86 (FIG. 2). A first part of the gear assembly 86 is the outer surface 82 of the second support wall 70 of the spool 34. A second part of the gear assembly 86 is a wobble gear 148. As shown in FIGS. 2 and 3, the wobble gear 148 is an annular gear having a first radially extending surface 150 and a second radially extending surface 152. The first radially extending surface 150 includes a plurality of teeth 154 for engaging the teeth 84 on the spool 34.

The wobble gear 148 further includes an inner axially extending surface 156 and an outer axially extending surface 158. The inner axially extending surface 156 of the wobble gear 148 is cylindrical and includes an annular rib 160 that extends radially inwardly at a location adjacent the second radially extending surface 152 of the wobble gear 148.

The retractor 26 further includes a spool bushing 162 and a wobble bearing 164. The spool bushing 162 is a cylindrical bushing for allowing rotation of the spool 34 at a rate different from the rotation of the rotor 110 of the electric motor 108. The wobble bearing 164 is preferably a ball bearing and includes a plurality of balls 165 that separate a cylindrical inner race 166 and a cylindrical outer race 168. The cylindrical inner race 166 of the wobble bearing 164 extends parallel to the cylindrical outer race 168 of the wobble bearing 164. The inner race 166 of the wobble bearing 164 has a diameter sized to fit securely against the inner surface 139 of the groove 138 on the outer surface 128 of the inner cylindrical wall 116 of the rotor 110. The outer race 168 is sized to fit securely against the inner axially extending surface 156 of the wobble gear 148.

To assemble the retractor 26 illustrated in FIGS. 2 and 3, an end of the seat belt webbing 20 is attached to the axle 66 of the spool 34 and the seat belt webbing 20 is wound around the axle 66 in the area between the first and second support walls 68 and 70. The second terminal end 74 of the axle 66 of the spool 34 is inserted through the center of the spool bushing 162 and the spool bushing 162 is pushed toward the outer surface 82 of the second support wall 70 of the spool 34. The spool 34 is then inserted through the hole 62 in the second side wall 50 of the frame 44, and the first terminal end 72 of the axle 66 of the spool 34 is inserted into the hole 56 in the first side wall 48 of the frame 44. It is important to note that the surface 58 defining the hole 56 in the first side wall 48 of the frame 44 acts as a bearing surface for allowing rotation of the spool 34 relative to the frame 44. A bearing may be inserted into the hole 56 if a reduction in friction is deemed necessary. When the first terminal end 72 of the axle 66 is inserted into the hole 56 in the first side wall 48 of the frame 44, a small gap separates the spool 34 from the first side wall 48 of the frame 44.

After the spool 34 is inserted into the frame 44, the stator 112 is fixed to the radially outer surface of the cylindrical extension 64 on the second side wall 50 of the frame 44. The stator 112 may be fixed to the cylindrical extension 64 in any known manner.

Next, the wobble bearing 164 is attached to the rotor 110 of the electric motor 108. The inner surface 139 defining a portion of the groove 138 in the inner cylindrical wall 116 of the rotor 110 is inserted through the center of the inner race 166 of the wobble bearing 164. The inner race 166 of the wobble bearing 164 is press fit against the inner surface 139 and abuts the end surface 141 of the groove 138. Thus, the inner race 166 of the wobble bearing 164 is fixed for rotation with the rotor 110.

Although the inner race 166 of the wobble bearing 164 is cylindrical, when located in the groove 138, the inner race 166 of the wobble bearing 164 is tilted such that the wobble bearing 164 is centered on axis B. During rotation of the rotor 110 about axis A, the inner race 166 of the wobble bearing 164 rotates about a point C located at the intersection of axis A and axis B. The outer race 168 of the wobble bearing 164 is connected to the inner race 166 of the wobble bearing 164 by the plurality of balls 165.

After the wobble bearing 164 is located in the groove 138, of the rotor 110, the wobble gear 148 is press fit to the outer race 168 of the wobble bearing 164. The outer race 168 of the wobble bearing 164 is inserted into the wobble gear 148 from the first radially extending surface 150 of the wobble gear 148. The outer race 168 is pushed toward the second radially extending surface 152 of the wobble gear 148 until the wobble bearing 164 contacts the annular rib 160 on the inner axially extending surface 156 of the wobble gear 148. Thus, the wobble gear 148 is fixed relative to the outer race 168 of the wobble bearing 164. When the wobble gear 148 is press fit on the outer race 168 of the wobble bearing 166, the center of the wobble gear 148 is on axis B.

Next, the second terminal end 74 of the axle 66 of the spool 34 is inserted into the tubular opening of the rotor 110 defined by the inner surface 130 of the inner cylindrical wall 116 of the rotor 110. The rotor 110 is pressed toward the outer surface 82 of the second support wall 70 of the spool 34 so that the spool bushing 162 becomes pressed in the opening defined by the inner surface 130 of the inner cylindrical wall 116 of the rotor 110.

When the spool bushing 162 contacts the annular rib 136 (FIG. 2) adjacent the second axial end 134 of the inner cylindrical wall 116, the outer cylindrical wall 114 of the rotor 110 is located radially outside and immediately adjacent the stator 112. A small gap separates the outer cylindrical wall 114 of the rotor 110 from the stator 112. Additionally, a small gap separates the rotor 110 from the spool 34.

When the rotor 10 is assembled in the retractor 26, some of the teeth 154 on the wobble gear 148 engage some of the teeth 84 on the spool 34, as shown in FIG. 2. Since the wobble gear 148 is centered on axis B and the spool 34 is centered on axis A, the wobble gear 148 is tilted relative to the spool 34. Thus, only the teeth 154 on the wobble gear associated with the position of portion X of the groove 138 will contact teeth 84 on the spool 34.

Finally, the second terminal end 74 of the axle 66 of the spool 34 is inserted into the hole 102 that extends through the end wall 96 of the motor cover 88. A short portion of the axle 66 adjacent the second terminal end 74 rests on the cylindrical extension 104 defining the hole 102 in the end wall 96 of the motor cover 88. The cylindrical extension 104 acts as a bearing surface for the axle 66 of the spool 34. A bearing may be inserted into the hole 102 if a reduction in friction is deemed necessary.

When the second terminal end 74 of the axle 66 is inserted into the hole 102 in the end wall 96 of the motor cover 88, the flange 106 that extends radially outwardly from the first axial end 92 of the main body portion 90 of the motor cover 88 contacts the second side wall 50 of the frame 44. Since both the flange 106 of the motor cover 88 and the second side wall 50 of the frame 44 have a generally square configuration, the flange 106 and the second side wall 50 are aligned. The flange 106 is attached to the second side wall 50 in a known manner, such as by using fasteners (not shown).

The electric motor 108 of the retractor 26 causes rotation of the spool 34. As will be discussed below, the spool 34 will not rotate relative to the housing 44 of the retractor 26 when the electric motor 108 is not energized. The electric motor 108 is energized by electric energy that is communicated to the electric motor 108 through the lead wires (not shown). The lead wires connect to the stator 112 and do not without interfere with the moving parts of the retractor 26. Although not shown in the drawings, the lead wires preferably exit the retractor 26 through an opening in the back wall 46 of the frame 44.

Upon receiving electric energy, the stator poles (not shown) of the stator 112 of the electric motor 108 are systematically energized to cause the rotor 110 to rotate in a particular direction. The general operation of an electric motor 108 is known in the art and, thus, will not be discussed in detail.

The inner race 166 of the wobble bearing 164 is fixed for rotation with the rotor 110. Thus, rotation of the rotor 110 causes rotation of the inner race 166 of the wobble bearing 164. During rotation of the rotor 110 about axis A, the inner race 166 of the wobble bearing rotates about point C.

The outer race 168 of the wobble bearing 164 and the wobble gear 148 wobble as a result of the rotation of the rotor 110 and the inner race 166. The term “wobble” as used herein may be described with analogy to the movement of a coin on a desktop. The coin has a diameter D1. A series of ten points A-J are marked on the circular outer periphery of the coin, spaced apart at equal intervals around the periphery. On the desktop there is drawn a circle of the same diameter D1. A series of ten points A′-J′ are marked on the circle, spaced apart at equal intervals around the perimeter of the circle.

If the coin lies flat on the desktop, on the circle, the point A engages and overlies the point A′, the point B engages and overlies the point B′, etc. If, however, the coin is tilted relative to the desktop, the coin touches the desktop at only one point, for example, the point A engages and overlies the point A′.

With the coin tilted in this manner, the outer periphery of the coin may then be moved continuously along the circle on the desktop so that first the point B on the coin is brought into engagement with and overlies the point B′ on the circle, then point C on the coin is brought into engagement with and overlies the point C′ on the circle, then point D on the coin is brought into engagement with and overlies the point D′ on the circle, and so forth. This movement is termed “wobble” as used herein. During this movement, the coin “wobbles” and is in constant contact with the desktop, changing position continuously relative to the desktop and without the coin rotating about its center. During this movement, a center point of the coin remains in a fixed location relative to the desktop.

In the retractor 26, the movement of the wobble gear 148 relative to the outer surface 82 of the second support wall 70 of the spool 34 is analogous to this movement of the coin relative to the desktop.

When the rotor 110 rotates, portion X of the groove 138 rotates about axis A and relative to the wobble gear 148, which is not rotating about its own axis. This movement of portion X causes the wobble gear 148 to continuously change position relative to the spool 34, just as the coin continuously changes position relative to the desktop without rotating. Sequential teeth 154 along the outer periphery of the wobble gear 148 are pushed into (and then pulled out of) engagement with teeth 84 along the outer periphery of the outer surface 82 of the second support wall 70 of the spool 34. During this movement, the wobble gear 148 remains centered on point C (FIG. 2).

If the wobble gear 148 and the spool 34 had the same number of teeth, the teeth would mesh perfectly during this relative movement. As a result, the wobble gear 148 would wobble relative to the spool 34, without causing rotation of the spool 34. That is, the sequential contact of the teeth 154 on the wobble gear 148 would not transmit rotational force to the teeth 84 on the spool 34 to cause the spool 34 to rotate. The wobble gear would move relative to the spool 34 in exactly the same manner as the coin moves relative to the desktop.

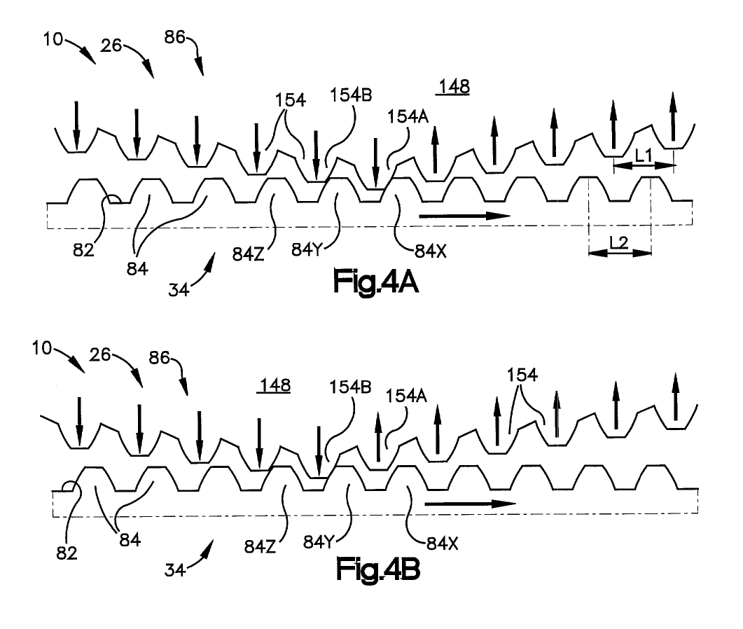

The wobble gear 148, however, has one more tooth than the spool 34. As a result, the teeth 154 on the wobble gear 148 are closer together than the teeth 84 on the spool 34. Thus, as shown in FIG. 4A, the distance L1 between adjacent teeth 154 on the wobble gear 148 is less than the distance L2 between adjacent teeth 84 on the spool 34. Because of the difference in the number of teeth, the wobbling movement of the wobble gear 148 causes its teeth 154 to transmit rotational force to the teeth 84 of the spool 34 as the wobble gear 148 wobbles relative to the spool 34. This can be seen with reference to FIGS. 4A-4B.

As the exemplary tooth 154A of the wobble gear 148 moves into engagement with the spool 34, the tooth 154A contacts the flank of a tooth 84X on the spool 34, rather than falling cleanly into a trough between the teeth 84X and 84Y on the spool 34, because the wobble gear teeth 154 are more closely spaced. The movement of the wobble gear tooth 154A into engagement with the spool gear tooth 84X thus has a component of force acting in a direction from left to right, as viewed in FIG. 4A, that causes circumferential movement of tooth 84X and thus rotation of the spool 34.

When the next succeeding gear tooth 154B of the wobble gear 148 thereafter moves into engagement with the spool 34, the tooth 154B contacts the flank of a gear tooth 84Y on the spool 34, rather than falling cleanly into the trough between the teeth 84Y and 84Z on the spool 34. The movement of the wobble gear tooth 154B into engagement with the spool gear tooth 84Y has a component of force acting in a direction from left to right as viewed in FIG. 4B, that causes circumferential movement of tooth 84Y and thus rotation of the spool 34.

In this manner, the wobbling movement of the wobble gear 148 continuously transmits a rotational force to the spool 34. This force is sufficient to rotate the spool 34 about the axis A as desired. It is noted that FIGS. 4A-4B depict rotation of the rotor 110 (and, therefore, portion X) in a clockwise direction to cause rotation of the spool 34 in a clockwise direction. Rotation of the rotor 110 in a counterclockwise direction will, in turn, cause rotation of the spool 34 in a counterclockwise direction.

Since the spool bushing 162 separates the axle 66 of the spool 34 from the rotor 110 of the electric motor 108, the rotor 110 and the spool 34 may rotate at different rates. As those skilled in the art will recognize, rotation of the spool 34 in a first direction will be a belt withdrawal direction, shown as 170 in FIG. 1, and rotation 34 of the spool in a second direction will be a belt retraction direction, shown as 172 in FIG. 1.

In summary, electric energy supplied to the stator 112 of the electric motor 108 causes the rotor 110 to rotate. Rotation of the rotor 110 causes the wobble gear 148 to wobble. Wobble of the wobble gear 148 is translated into rotation of the spool 34 of the retractor 26.

As shown in FIG. 1, the vehicle occupant safety system 10 further includes a sensor 174. The sensor 174 senses the occurrence a vehicle crash condition and generates a signal indicative of the crash condition.

The vehicle occupant safety system 10 also includes a force detection device 176 for detecting a force applied to the seat belt webbing 20. Preferably, the force detection device 176 is a micro-electro mechanical (MEMs) strain sensitive transducer. As illustrated in FIG. 1, the force detection device 176 is located on the anchor 38 for the buckle 36. Those skilled in the art will recognize that the force detection device 176 may be located in other areas of the vehicle occupant safety system 10, such as on the seat belt webbing 20. The force detection device 176 detects the force applied to the seat belt webbing 20 and generates a signal indicative of the detected force.

A buckle sensing switch 178 (FIG. 1) is located in the buckle 36 of the vehicle occupant safety system 10. The buckle sensing switch 178 determines if the tongue assembly 28 is latched in the buckle 36. Preferably, the buckle sensing switch 178 is a Hall effect device. The buckle sensing switch 178 generates a signal indicative of the buckled condition of the tongue assembly 28 but generates no such signal if the tongue assembly 28 is not latched in the buckle 36.

The vehicle occupant safety system 10 further includes a controller 180 (FIG. 1). The controller 180 preferably includes a microprocessor. The controller 180 is electrically connected to the electric motor 108 of the retractor 26, as shown schematically in FIG. 1. The controller 180 is also electrically connected to and receives signals from the sensor 174, the force detection device 176, and the buckle sensing switch 178. The controller 180 receives electric energy from an electric power source 182. Depending upon the signals received by the controller 180 from the sensor 174, the force detection device 176, and the buckle sensing switch 178, the controller 180 determines whether or not to supply electric energy to the electric motor 108 of the retractor 26.

The electric motor 108 has alternate modes of operation, each being dependent upon the electric energy supplied by the controller 180. If the controller supplies electric energy to the electric motor 108 of the retractor 26, the controller 180 also determines the mode of operation of the electric motor 108.

In a first mode of operation, electric motor 108 of the retractor 26 may rotate the spool 34 in either the belt withdrawal direction 170 or the belt retraction direction 172. The controller 180 will operate the electric motor 108 in the first mode of operation in an absence of a signal indicative of a crash condition from the sensor 174. To operate the electric motor 108 in the first mode of operation, the controller 180 supplies to the electric motor 108 electric energy having a constant voltage and an amperage with a magnitude in a predetermined range. Preferably, the voltage is about 42 volts and the amperage ranges from about 0.25 amps to about 1 amp. Upon receipt of the electric energy, the electric motor 108 causes the spool 34 of the retractor 26 to rotate in either the belt retraction direction 172 or the belt withdrawal direction 170.

In a second mode of operation, the electric motor 108 of the retractor 26 only rotates the spool 34 in a belt retraction direction 172. The controller 180 operates the electric motor 108 in the second mode of operation when a signal indicative of a crash condition is received from the sensor 174. To operate the electric motor 108 in the second mode of operation, the controller 180 supplies to the electric motor 108 electric energy having an amperage with a magnitude that is greater than the predetermined range of amperages received in the first mode of operation. Preferably in the second mode of operation, the voltage remains at about 42 volts and the amperage ranges from about 60 amps to about 100 amps. Upon receipt of the higher amperage electric energy, the electric motor 108 rotates rapidly in the belt retraction direction 172. The controller 180 only operates the electric motor 108 in the second mode of operation for a short period of time, approximately 10 to 20 milliseconds. This short period of high amperage electric energy allows the retractor 26 to act as a pretensioner 24. Additionally, the short actuation period combined with the thermal time constant of the electric motor 108 prevents the electric motor 108 from becoming overheated and damaged.

A detailed explanation of a preferred manner of the operation of the vehicle occupant safety system 10 follows. Those skilled in the art will recognize that the operation of the vehicle occupant safety system 10 may be changed without varying the scope of this invention.

If the controller 180 receives a first set of signals, controller 180 will assume the seat belt webbing 20 is in a retracted position, as shown in solid lines in FIG. 1. The first set of signals that the controller must receive are signals indicating that no vehicle crash condition exists, that the tongue assembly 28 is not latched in the buckle 36 and the tongue assembly 28 was not just recently unlatched from the buckle 36, and that there is no force being applied to the seat belt webbing 20. As a result, the controller 180 will not supply any electric energy to the electric motor 108 of the retractor 26.

If the controller 180 receives a second set of signals, the controller 180 will assume that the seat belt webbing 20 is withdrawn from the retractor 26. The second set of signals are signals indicating that no vehicle crash condition exists, that the tongue assembly 28 is not latched in the buckle 36 but was just recently unlatched from the buckle 36, and that there is no force being applied to the seat belt webbing 20. Since the controller 180 has not received a signal indicating a vehicle crash condition, the controller 180 will operate the electric motor 108 in the first mode of operation. As a result, the controller 180 will energize the electric motor 108 of the retractor 26 to rotate the spool 34 in the belt retraction direction 172 until the seat belt webbing 20 is in a retracted position.

If the controller 180 receives a third set of signals, the controller 180 will assume that the vehicle occupant 12 is attempting to withdraw the seat belt webbing 20 from the retractor 26. The third set of signals are signals indicating that no vehicle crash condition exists, that the tongue assembly 28 is not latched in the buckle 36 and the tongue assembly 28 was not just recently unlatched from the buckle 36, and that there is a force being applied to the seat belt webbing 20. Since the controller 180 has not received a signal indicating a vehicle crash condition, the controller 180 will operate the electric motor 108 in the first mode of operation. As a result, the controller 180 will send electric energy having an amperage in the predetermined range to the electric motor 108 of the retractor 26 to cause the spool 34 to rotate in the belt withdrawal direction 170. The controller 180 will cause the spool 34 to rotate in the belt withdrawal direction 170 until the force detection signal generated by the force detection device 176 equal zero. When the force detection signal equals zero, the controller 180 will review the signal generated by the buckle sensing switch 178 to determine if the tongue assembly 28 is latched in the buckle 36. If the tongue assembly 28 is latched in the buckle 36, the controller 180 will actuate the retractor 26 to tighten the seat belt webbing 20 around the occupant 12. Thus, the controller 180 will send electric energy having an amperage in the predetermined range to the electric motor 108. The electric motor 108 will cause the spool 34 to rotate in the belt retraction direction 172. The spool 34 will rotate in the belt retraction direction 172 until a force of a first predetermined level is detected. The first predetermined level of force is a force in the seat belt webbing ranging from about 0.5 pounds-force to about 3 pounds-force. Preferably, the first predetermined level of force is about 1 pound-force. The force of a first predetermined level is detected by the force detection device 176 and will indicate a snug fit of the seat belt webbing 20 around the occupant 12. Particularly, the first predetermined level of force indicates a snug fit of the torso portion 40 of the seat belt webbing 20. If the controller 180 determines that the tongue assembly 28 is not latched in the buckle 36, the controller 180 will cause the spool 34 to rotate in the belt retraction direction 172 until the seat belt webbing 20 is in the retracted position.

If the controller 180 receives a fourth set of signals, the controller 180 will assume that the occupant 12 is attempting to lean forward in the vehicle seat 14. The fourth set of signals are signals indicating that no vehicle crash condition exists, that the tongue assembly 28 is latched in the buckle 36, and that the force being applied to the seat belt webbing 20 is above the first predetermined level. A view of an occupant 12 leaning forward in the seat is illustrated in FIG. 5. Since the controller 180 has not received a signal indicating a vehicle crash condition, the controller 180 will operate the electric motor 108 in the first mode of operation. As a result, the controller 180 will energize the electric motor 108 to cause the spool 34 to rotate in the belt withdrawal direction 170 until the detected force again reaches zero. When the detected force reaches zero, the controller 180 will cause the spool 34 to rotate in the belt retraction direction 172 until the force on the seat belt webbing 20 again reaches the first predetermined level. If the occupant 12 subsequently leans back against the back portion 18 of the seat 14, as illustrated in FIG. 6, the force detected in the seat belt webbing 20 will fall below the first predetermined level. As a result, the controller 180 will cause spool 34 to rotate in the belt retraction direction 172 until the force on the seat belt webbing 20 again reaches the first predetermined level.

If the controller 180 receives signals indicating that a vehicle crash condition exists, and that the tongue assembly 28 is not latched in the buckle 36, the controller 180 will not energize the electric motor 108 of the retractor 26.

If the controller 180 receives signals indicating that a vehicle crash condition exists, and that the tongue assembly 28 is latched in the buckle 36, the controller 180 will cause the electric motor 108 to operate in the second mode of operation. As a result, the controller 180 will supply high amperage electric energy to the electric motor 108 to rotate the spool 34 rapidly in the belt retraction direction 172. The spool 34 will be rotated in the belt retraction direction 172 for a short period of time. The rapid rotation of the spool 34 will retract about 4 to 5 inches of seat belt webbing and will produce a force on the seat belt webbing up to approximately 562 pounds-force in 10 to 20 milliseconds. Thus, when a crash condition is sensed, the retractor 26 acts as a pretensioner 24. The force on the seat belt webbing 20 generated by the electric motor 108 operating in the second mode of operation is sufficient to pull an occupant 12 of the vehicle seat 14 who is leaning forward (as shown in FIG. 5) backward to a position against the back portion 18 of the seat (as shown in FIG. 6).

The vehicle occupant safety system 10 may further include a number of sensors that indicate impending occupant danger. These could include inertial yaw stability sensors, extreme high vehicle speed indicators, or proximity sensors, such as the proximity sensor indicated at 184. The proximity sensor 184 is a known device that senses the distance of an object from the vehicle and that determines if a crash condition between the vehicle and the object is impending. If a crash condition is impending, the proximity sensor 184 generates a signal indicative of the impending condition. A known proximity sensor 184 uses radar to sense the proximity of the object to the vehicle. The proximity sensor 184 is electrically connected to the controller 180, and the controller 180 receives the signal generated by the proximity sensor 184.

If the vehicle occupant safety system 10 includes a proximity sensor 184, the electric motor 108 will also include a third mode of operation. The third mode of operation is at an amperage level between that of the first mode of operation and the second mode of operation. The third mode of operation will last for a period of approximately 120 milliseconds and will not cause undue harm to the electric motor 108 because of the thermal time constant of the electric motor 108. In the third mode of operation, the retractor 26 acts as a precrash pretensioner 24. The electric motor 108 rotates the spool 34 in only the belt retraction direction 172, and a second predetermined level of force is applied to the seat belt webbing 20. The second predetermined level of force is approximately 55 pounds-force.

If the controller 180 receives a signal from the proximity sensor 184 and if the tongue assembly 28 is latched in the buckle 36, the controller 180 will operate the electric motor 108 in the third mode of operation. If the signal from the proximity sensor 184 subsequently disappears, the controller 180 will return operation of the electric motor 108 to the first mode of operation and will adjust the seat belt webbing to the first predetermined level of force. If a signal is subsequently received from sensor 174, the controller 180 will operate the electric motor 108 in the second mode of operation.

When a crash condition is sensed and the electric motor 108 is not energized, e.g., in the event of an electric power failure or after the short period of operation in the second mode, the gear assembly 86 will prevent the withdrawal of seat belt webbing 20 from the retractor 26. The gear assembly 86, formed by the second support wall 70 of the spool 34 and the wobble gear 148, is non-backdrivable. Non-backdrivable means that a force tending to rotate the spool 34 will not cause the wobble gear 148 to wobble. As a result, the teeth 154 of the wobble gear 148 will remain in meshing engagement with teeth 84 of the second support wall 70 of the spool 34. Thus, the wobble gear 148 will act as a locking mechanism to prevent rotation of the spool 34 and to prevent withdrawal of the seat belt webbing 20 from the retractor 26. The gear assembly 86 of the retractor 26 can withstand a force on the seat belt webbing 20 of up to approximately 2,300 pounds-force.

From the above description of the invention, those skilled in the art will perceive improvements, changes and modifications. For example, additional structure may connect the wobble gear 148 to the frame 44 to prevent rotation of the wobble gear 148. If such structure is used, the structure must not interfere with a wobbling movement of the wobble gear 148, as will be described below. Also, the electric motor 108 may be a variable reluctance motor. Such improvements, changes and modifications within the skill of the art are intended to be covered by the appended claims.

Having described the invention, the following is claimed:

1. A vehicle occupant safety system for helping to protect an occupant of a vehicle seat during a crash condition, the system comprising:
at least one sensor for sensing a vehicle crash condition and generating a signal indicative of the crash condition;
seat belt webbing for extending around the vehicle occupant; and
a pretensioner responsive to the signal generated by the sensor for acting on the seat belt webbing to pull an occupant of the vehicle seat who is forward in the vehicle seat backward toward a back portion of the vehicle seat,
the pretensioner comprising a seat belt retractor, the seat belt retractor including a spool on which the seat belt webbing is wound and an electric motor for rotating the spool in a belt retraction direction to pull the occupant backward toward the back portion of the vehicle seat.

2. The system of claim 1 further being defined by:
the electric motor being drivingly connected to the spool by a gear assembly; and
a portion of the spool forming part of the gear assembly

3. The system of claim 1 further being defined by:
the electric motor being drivingly connected to the spool by a non-backdrivable gear assembly;
the non-backdrivable gear assembly further being a locking mechanism that prevents rotation of the spool when the electric motor is not energized.

4. The system of claim 3 further being defined by:
the non-backdrivable gear assembly including a wobble gear and a portion of the spool;
the wobble gear having a plurality of teeth and the portion of the spool having a plurality of teeth, at least some of the teeth of the wobble gear being in meshing engagement with at least some of the teeth of the portion of the spool;
the plurality of teeth of the wobble gear including one more tooth than the plurality of teeth of the portion of the spool.

5. The system of claim 3 further including:
a controller electrically connected to the electric motor;
the controller also being electrically connected to the sensor and receiving the signal generated by the sensor;
upon receipt of the signal, the controller actuating the pretensioner.

6. The system of claim 5 further including:
a force detection device for detecting a force applied to the seat belt webbing;
the force detecting device being electrically connected to the controller and sending the controller a signal indicative of detected force.

7. The system of claim 6 further being defined by:
the force detection device being a micro-electro mechanical strain sensitive transducer.

8. The system of claim 6 further including:
a buckle sensing switch for detecting if a tongue assembly is latched into a buckle, the tongue assembly being adjustably connected with the seat belt webbing;
the buckle sensing switch being electrically connected to the controller and sending the controller a signal indicative of a latched condition of the buckle.

9. The system of claim 8 further being defined by:
the buckle sensing switch being a Hall effect device.

10. The system of claim 1 further being defined by:
the electric motor having a first mode of operation and a second mode of operation;
the first mode of operation occurring in an absence of the signal from the sensor, the first mode of operation allowing the electric motor to rotate the spool in the belt retraction direction and in a belt withdrawal direction, opposite the belt retraction direction;
the second mode of operation occurring upon receipt of the signal from the sensor, the second mode of operation causing the electric motor to actuate the pretensioner to rotate the spool in the belt retraction direction to pull the occupant backward toward the back portion of the vehicle seat.

11. The system of claim 10 further being defined by:
in the first mode of operation, the electric motor receiving electric energy with an amperage in a predetermined range, and
in the second mode of operation, the electric motor receiving electric energy with an amperage greater than the predetermined range.

12. The system of claim 10 further being defined by:
in the first mode of operation, the electric motor rotating the spool to apply a first predetermined force to the seat belt webbing, and
in the second mode of operation, the electric motor rotating the spool to apply a force to the seat belt webbing that is greater than the first predetermined force.

13. The system of claim 11 further including:
a controller being electrically connected to the electric motor and controlling electric energy supplied to the electric motor.

14. The system of claim 10 further including:
an inertial yaw stability, an extreme vehicle speed, or a proximity sensor for determining if a crash condition is impending and generating a signal indicative of the impending condition,
the electric motor further including a third mode of operation, the electric motor operating in the third mode of operation upon receiving the signal from the proximity sensor, the third mode of operation causing the electric motor to actuate the pretensioner to rotate the spool in the belt retraction direction to pull the occupant backward toward the back portion of the vehicle seat, the third mode of operation resulting in a force on the seat belt webbing that is less than a force generated in the second mode of operation.

15. The system of claim 10 further including:
a gear assembly for transmitting power from the electric motor to the spool,
rotation of the electric motor causing wobbling of a part of the gear assembly,
wobbling of a part of the gear assembly causing rotation of the spool.
